(19) United States
(12) Patent Application Publication
(10) Pub. No.: US 2026/0104261 A1
(43) Pub. Date: Apr. 16, 2026

(54) DYNAMIC VEHICLE ROUTING WITH PROMPT CONFIRMATION AND CONTINUALLY OPTIMIZED ROUTE ASSIGNMENTS

(71) Applicants: Vanderbilt University, Nashville, TN (US); The Penn State Research Foundation, University Park, PA (US); Cornell University, Ithaca, NY (US)

(72) Inventors: Amutheezan Sivagnanam, University Park, PA (US); Ayan Mukhopadhyay, Nashville, TN (US); Samitha Samaranayake, Ithaca, NY (US); Abhishek Dubey, Nashville, TN (US); Aron Laszka, University Park, PA (US)

(21) Appl. No.: 19/353,018

(22) Filed: Oct. 8, 2025

Related U.S. Application Data
(60) Provisional application No. 63/704,837, filed on Oct. 8, 2024.
(60) Provisional application No. 63/757,124, filed on Feb. 11, 2025.

(51) Int. Cl. G01C 21/34; G06N 3/092; G06N 3/096

(52) U.S. Cl. CPC G01C 21/3446; G06N 3/092; G06N 3/096

(57) ABSTRACT

Existing dynamic vehicle routing systems for microtransit services either provide prompt confirmation (without continually optimizing vehicle routes, which reduces system efficiency) or continually optimize vehicle routes (without providing immediate service guarantees, which hinders user satisfaction and adoption). The disclosed system overcomes that tradeoff by integrating a prompt confirmation module (that provides near-instantaneous acceptance or rejection) with an anytime optimization module (that continuously improves vehicle manifests during the idle periods between request arrivals). To provide guaranteed service while simultaneously optimizing vehicle route for maximum system efficiency, both the prompt confirmation module and the anytime optimization module are guided by a non-myopic objective function (a state-action value function learned by training a neural network using reinforcement learning and, in some embodiments, accelerated via supervised pre-training) that maximizes the long-term service rate.

### CROSS-REFERENCE TO RELATED APPLICATIONS

This application claims priority to U.S. Prov. Pat. Appl. No. 63/704,837, filed Oct. 8, 2024, and U.S. Prov. Pat. Appl. No. 63/757,124, filed Feb. 11, 2025, which are hereby incorporated by reference.

### FEDERAL FUNDING

This invention was made with government support under Award Number 1952011 awarded by the National Science Foundation (NSF). The government has certain rights in the invention.

### BACKGROUND

Transit agencies that operate microtransit services have to respond to trip requests in real time, a sequential decision-making problem that involves solving a dynamic vehicle routing problem with pick-up and drop-off constraints. The Dynamic Vehicle Routing Problem (DVRP), also known as the Online VRP, is a sequential decision-making problem that models the operation of a transportation service that has to serve requests for transportation to various locations using a set of vehicles (e.g., ride sharing, paratransit, or microtransit service). A key aspect of the DVRP problem is uncertainty: the requests arrive sequentially while the vehicles are in operation, serving earlier requests, and future requests are stochastic, i.e., only their distribution is known. When modeling passenger transportation, it is typically assumed that each received request has a pickup location, a dropoff location, an earliest pickup time, a latest dropoff time, and a number of passengers; and the passengers must be picked up and dropped off by a vehicle within that window. A natural objective for this problem is maximizing service rate, i.e., maximizing the number of requests accepted and served within their time windows using a given set of vehicles with limited passenger capacities.

Existing computational approaches for this problem can be divided into two categories. One category of algorithms decide whether to accept or reject a request when it is received, and they immediately assign an accepted request to a vehicle manifest. That approach provides better usability for passengers (because requests are confirmed promptly and passengers have no uncertainty). However, that approach does not provide the ability for the service provider to continuously improve vehicle manifests, which is crucial because prompt confirmation does not allow for extensive computation when a request is received.

The other category of algorithms delay the confirmation of acceptance and continuously recalculate assignments as requests arrive. That approach is advantageous from the perspective of the service provider since the malleability of the vehicle manifests (i.e., flexibility to change the assignment and order of requests) can lead to a higher service rate. However, prompt confirmation is crucial in many practical applications (especially in emerging on-demand microtransit services). If passengers cannot confirm within a reasonable time that their requests will be served within the requested pickup-dropoff time windows, they might decide not to use the service (e.g., people seeking to use on-demand public transit for work commute or medical appointments).

Because existing computational approaches cannot both provide immediate confirmation that a microtransit request will be satisfied and continually optimize the requests that have already been accepted, systems with fixed fleets of vehicles (e.g., municipal microtransit services) typically assign advance requests immediately—and provide immediate confirmation to users-without later optimizing those accepted requests. Meanwhile, other systems that provide continual optimization (such as Uber and Lyft) typically refrain from guaranteeing that a request will be satisfied and will instead simply try to assign a request made in advance to a vehicle shortly before the requested pick-up time.

Accordingly, there is a system that is capable of providing prompt confirmation for all incoming requests while simultaneously enabling the continuous improvement of vehicle manifests.

### SUMMARY

The disclosed system overcomes those and other drawbacks of the prior art by leveraging the time intervals between the arrivals of consecutive requests-intervals during which existing prompt confirmation solutions remain idle. To bridge that gap, the disclosed system introduces a novel methodology that integrates a prompt confirmation module for immediate request confirmation with an anytime optimization algorithm that continuously improves vehicle manifests during the periods between request arrivals.

In operation, the prompt confirmation module is configured to provide near-instantaneous confirmation, accepting or rejecting each incoming request within a fraction of a second, thereby enhancing usability for passengers. Concurrently, the anytime optimization module persistently seeks to improve vehicle manifests between request arrivals, thereby increasing the overall service rate. A central challenge addressed by the disclosed system involves the selection of an appropriate objective function for the anytime optimization module. While maximizing the service rate may appear to be an obvious objective, it is insufficient, as the set of confirmed (i.e., accepted or rejected) requests remains unchanged between the arrivals of consecutive requests. Accordingly, the objective function must be non-myopic: it must maximize the probability of accepting future requests and enable subsequent improvements to the vehicle manifests, thereby optimizing service rate over the long term. The disclosed system achieves that goal by continually seeking route arrangements that leave vehicles in positions and with schedules that maximize their flexibility to incorporate potential future requests.

To that end, the disclosed system formulates the problems of request confirmation and manifest optimization as a sequential decision-making process under uncertainty, specifically as a Markov decision process (MDP). In that context, a state is defined as the current configuration of the transportation service, including vehicle locations, the number of passengers aboard each vehicle, the set of accepted requests, the present vehicle manifests, and the most recently received trip request. An action corresponds to the acceptance or rejection of the most recent request by the prompt confirmation module or the selection of updated manifests by the anytime optimization module. The disclosed system applies reinforcement learning techniques to approximate the action-value function of the optimal policy within this MDP framework, thereby identifying the objective function that maximizes service rate in the long term. In some embodiments, supervised pre-training is used to provide a coarse objective function and improve the convergence speed of the initial reinforcement learning process.

### BRIEF DESCRIPTION OF THE DRAWINGS

FIG. 1 is a block diagram illustrating a dynamic vehicle routing system according to exemplary embodiments.

FIG. 2 is a flowchart illustrating a dynamic vehicle routing process according to exemplary embodiments.

FIG. 3 is a block diagram of a process for leaning a non-myopic objective function using reinforcement learning according to exemplary embodiments.

FIG. 4 is a block diagram of a supervised pre-training process for learning a coarse objective function, which that then be refined using the reinforcement learning process of FIG. 3 to learn a fine-tuned objective function, according to exemplary embodiments.

### DETAILED DESCRIPTION

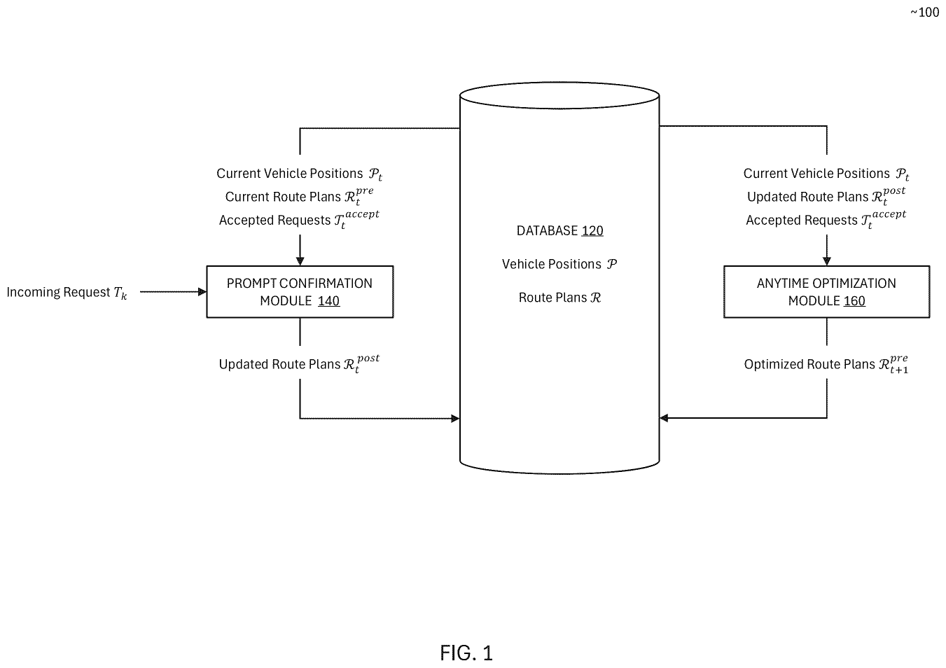

FIG. 1 is a block diagram illustrating a dynamic vehicle routing system 100 according to exemplary embodiments. As shown in FIG. 1, the system includes a database 120, a prompt confirmation module 140, and an anytime optimization module 160. The database 120 includes the current positions [symbol] and route plans [symbol] of each vehicle v in a fixed fleet of vehicles V.

As described in detail below, the prompt confirmation module 140 decides whether to accept or reject incoming request Tₖ based on the current state of the environment (i.e., the current positions [symbol] ={L^{v}^{ᵢ} ∈ [symbol] | i=1, . . . , | [symbol] |} of each vehicle v∈ [symbol] and the set of requests [symbol] that are in the current route plans [symbol] for each vehicle v∈ [symbol] ) and stores a set of updated route plans [symbol] for each vehicle v∈ [symbol] in the database 120.

Additionally, the anytime optimization module 160 continually generates sets of optimized route plans [symbol] based on the current positions [symbol] ₜ={L^{v}^{ᵢ} ∈ [symbol] |i=1, . . . , |V|} of each vehicle v∈ [symbol] , the accepted requests [symbol] , and the latest route plans [symbol] post for each vehicle V∈ [symbol] .

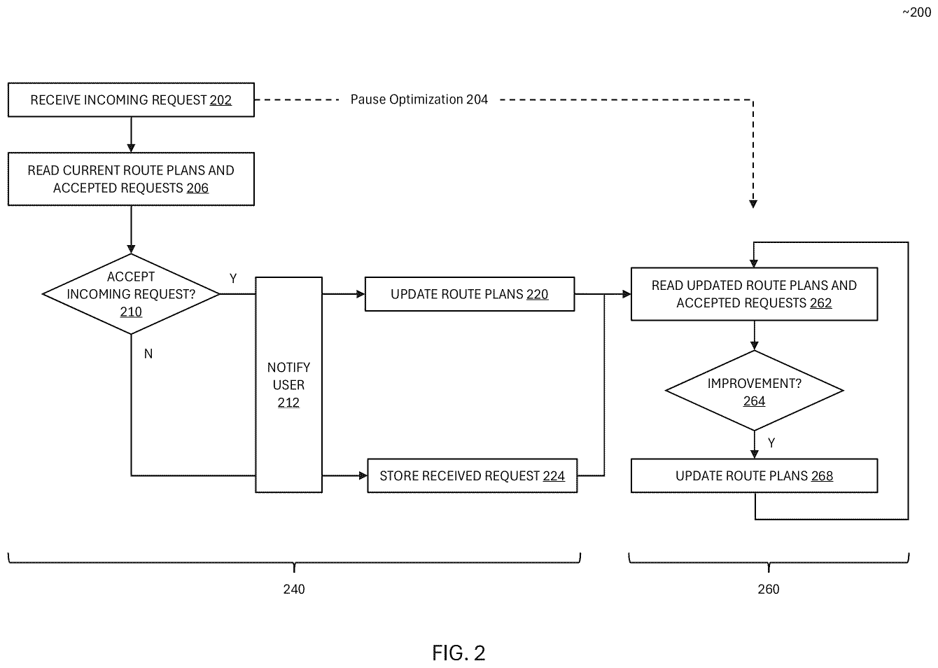

FIG. 2 is a flowchart illustrating a dynamic vehicle routing process 200 according to exemplary embodiments. As shown in FIG. 2, the dynamic vehicle routing process 200 includes both a prompt confirmation process 220 (performed by the prompt confirmation module 140 as described in more detail below) and a route optimization process 260 (performed by the anytime optimization module 160 as described in more detail below).

An incoming request Tₖ is received in step 202 and the route optimization process 260 is paused in step 204. The current route plans [symbol] and accepted requests [symbol] are read from the database 120 by the prompt confirmation module 140 in step 206 and a decision is made in step 210 as to whether the incoming request Tₖ is accepted or not. If the incoming request Tₖ is accepted (step 210: Yes), the user is notified in step 212, a set of updated route plans [symbol] is stored in the database 120 in step 220, and the route optimization process 260 resumes. In the route optimization process 260, the updated route plans [symbol] and accepted requests [symbol] are read from the database 120 by the anytime optimization module 160 in step 262 and, if an improvement is identified (step 264: Yes), the optimized route plans [symbol] are stored in the database 120 in step 268. If the incoming request is not accepted (step 210: No), the user is notified in step 212, the incoming request Tₖ is stored in a queue, the route optimization process 260 resumes. In those instances, the anytime optimization module 160 determines if a set of optimized route plans [symbol] exists to serve both the accepted requests [symbol] and, if possible, any request Tₖ stored in the queue that has yet to be accepted.

As described in detail below, both the prompt confirmation module 140 and the anytime optimization module 160 ensure that all of the routes in each set of route plans [symbol] are feasible, meaning they serve all of the accepted requests and satisfy all the constraints described below (e.g., travel times between locations). By making sure that the database 120 always includes a set of feasible route plans [symbol] (that, together, serve all the accepted requests [symbol] , the disclosed system 100 ensures that all the accepted requests [symbol] [symbol] will be served.

To determine the optimal assignment of any incoming request Tₖ during the prompt confirmation process 220 and to provide an objective for the route optimization process 260, the disclosed system 100 establishes a non-myopic objective that helps to maximize service rate in the long term.

Throughout the day, the prompt confirmation module 140 receives requests [symbol] ={T₁,T₂, . . . } that arrive up to time t. Each request Tₖ∈ [symbol] is received by the prompt confirmation module 140 at arrival time

$${τ}_{k}^{arrival} ∈$$

and contains a pickup location L_{T}^{pickup} ∈ [symbol] and/or a pickup dropoff location

$${L}_{T}^{dropoff} ∈$$

(from among a set of locations [symbol] representing all points in the road network), an earliest pickup time

$${τ}_{k}^{earliest} ∈$$

and/or a latest dropoff time

$${τ}_{k}^{earliest} ∈ ,$$

and a number of passengers nₖ(nₖ∈ [symbol] ).

To provide micro-transit services using a set of vehicles [symbol] with a fixed passenger capacity of c, the dynamic vehicle routing system 100 generates and optimizes a route plan Rᵥ for each vehicle v∈ [symbol] . Each route plan Rᵥ={(\hat{L}ₖ,\hat{τ}ₖ,\hat{n}ₖ)|k=1, 2, . . . , |Rᵥ|} includes pick-up or drop-off locations \hat{L}ₖ∈ [symbol] , the time \hat{τ}ₖ∈ [symbol] at which the vehicle v leaves each 1 pick-up or drop-off location \hat{L}ₖ, and the change in the occupancy \hat{n}ₖ∈{±1, ±2, . . . , ±c} after leaving each pick-up or drop-off location \hat{L}ₖ. At the beginning of the day, the route plan Rᵥ for each vehicle v∈ [symbol] is an empty set. Each vehicle v∈ [symbol] starts from the depot location L^{depot} of the transit agency at a start time v^{start} ∈ [symbol] , serves the requests Tₖ∈ [symbol] along the way as the route plan [symbol] for the vehicle v∈ [symbol] gets updated in real-time, and returns back to the depot location L^{depot} by an end time v^{end} ∈ [symbol] .

### Prompt Confirmation

Referring back to FIG. 1, upon the arrival of an incoming request Tₖ at time t, the prompt confirmation module 140 then makes a decision (action aₜ) as to whether the incoming request Tₖ can be accepted or not based on the current state sₜ of the environment at time t (i.e., the current position [symbol] of each vehicle v∈ [symbol] , the set of requests [symbol] that have been accepted but not completely served, the route plans [symbol] of each vehicle v E V, and the incoming request Tₖ). In some embodiments, for example, the prompt confirmation module 140 accepts the incoming request Tₖ if it is feasible to do so while satisfying the following real-world constraints related to the vehicle assignments, time windows, and vehicle occupancy:
1. The incoming request Tₖ can be assigned to at most one vehicle while satisfying time-window constraints (i.e., the incoming request Tₖ must be picked up after

$${t}_{k}^{earliest}$$

and dropped off before

$${t}_{k}^{latest} ) .$$

2. Each request Tⱼ∈ [symbol] that is already picked up must keep its vehicle assignment unchanged and be dropped off before

$${t}_{j}^{latest} .$$

3. Each request Tⱼ∈ [symbol] that is not yet picked up must be assigned to exactly one vehicle, satisfying the time-window constraints (i.e., the request must be picked after

$${t}_{j}^{earliest}$$

and dropped off before

$${t}_{j}^{latest} ) .$$

4. The maximum occupancy of vehicle v∈ [symbol] should not exceeds the maximum passenger capacity c at any point during its route.

As a result of each action at by the prompt confirmation module 140, the pre-decision state sₜ of the environment transitions into the post-decision state

$${s}_{t}^{post}$$

and the route plans

$${R}_{t}^{pre}$$

at the arrival of requested Tₖ are transformed into post-decision route plans

$${R}_{t}^{post}$$

for each vehicle v∈V. If the action aₜ performed by the prompt confirmation module 140 is to accept the incoming request Tₖ, the prompt confirmation module 140 adds that incoming request Tₖ to the set of accepted requests

$$= ⋃ \{ {T}_{k} \} ) .$$

Otherwise, the set of accepted requests remains unchanged ( [symbol] = [symbol] ).

The reward for performing an action aₜ is governed by the reward function r(sₜ,aₜ). As briefly mentioned above, the dynamic vehicle routing system 100 learns to maximize the service rate (i.e., the percentage of accepted requests [symbol] out of all the requests [symbol] received by time t). To that end, if the action aₜ performed by the prompt confirmation module 140 is acceptance of the incoming request Tₖ, the reward function r(sₜ,aₜ)=1; otherwise, the reward function r(sₜ,aₜ)=0. To determine the optimal vehicle v E V in which to assign the new request Tₖ∈ [symbol] , the prompt confirmation module 140 estimates the discounted sum of all future rewards using a state-action value function:

$$( state , action ) = ( ( , {T}_{k} , , ) , ) \qquad [ Equation 1 ]$$

where ( [symbol] ,Tₖ, [symbol] , [symbol] ) represent the current state of environment and [symbol] represents the set of solutions for the current state.

As described in detail below, the state-action value function is a non-myopic objective function learned using reinforcement learning.

### Continual Optimization

Between the arrival of each new request Tₖ, the anytime optimization module 160 optimizes the current route plans [symbol] generated by the prompt confirmation module 140 and outputs optimized route plans [symbol] The input of the anytime optimization module 160 at time t is the current position [symbol] ={L^{v}^{ᵢ} ∈ [symbol] |i=1, . . . , |V|} of each vehicle v∈ [symbol] , the accepted and unserved requests [symbol] , and the current route plans [symbol] for each vehicle v∈ [symbol] . In some embodiments, the optimized route plans [symbol] generated by the anytime optimization module 160 must satisfy many of the real-world constraints related to the vehicle assignment, time windows, and vehicle occupancy described above:
1. Each request Tⱼ∈ [symbol] that is already picked up must keep its vehicle assignment unchanged and be dropped off before

$${t}_{j}^{latest} .$$

2. Each request Tⱼ∈ [symbol] that is not yet picked up must be assigned to exactly one vehicle, satisfying the time-window constraints (i.e., the request must be picked after

$${t}_{j}^{e a rliest}$$

and dropped oft before

$${t}_{j}^{latest} ) .$$

3. The maximum occupancy of vehicle v∈ [symbol] should not exceeds the maximum passenger capacity c at any point during its route.

To maximize the service rate as described above, the anytime optimization module 160 estimates the discounted sum of all future rewards using the same state-action value function as the prompt confirmation module 140:

$$( state , action ) = ( ( , , ) , ) \qquad [ Equation 2 ]$$

where ( [symbol] , [symbol] , [symbol] ) represent the current state of environment and [symbol] represents the set of solutions for the current state.

The anytime optimization module 160 then selects the optimized route plans [symbol] having the maximum estimated value as follows:

$$= argmax ( ( , , ) , ) \qquad [ Equation 3 ]$$

Because solving that optimization problem is computationally hard, the anytime optimization module 160 utilizes simulated annealing or another optimization algorithm. In embodiments that utilize simulated annealing, during each iteration the anytime optimization module 160 randomly perform a set of mutation operations such as Swap: swapping the vehicle assignments of two randomly chosen unserved requests from each of two randomly chosen route plans; Move: moving one randomly chosen unserved request from a first randomly chosen route plan to a second randomly chosen route plan; 2-opt: iteratively removing two edges from a route plan and reconnect the two resulting paths in the opposite way; Shift: shift the ordering of one randomly chosen stop (either a pick-up or drop-off) in a randomly chosen one route plan; and Reverse: reverse the ordering of two or more randomly selected stops in a randomly selected route plan.

At the arrival of next request Tₖ, the optimization process performed by the anytime optimization module 160 is paused and the database 120 is updated to reflect the optimized route plans [symbol] generated by the anytime optimization module 160. Simulated annealing is an anytime meta-heuristic algorithm that is particularly well suited for the disclosed anytime optimization task because it can return the best available solution when paused in response to the next incoming request Tₖ. Other anytime meta-heuristic algorithms can return the best available solution when paused include Tabu Search (TS), Adaptive Large Neighborhood Search (ALNS), and Iterated Local Search (ILS).

### Non-Myopic Objective

To maximize the service rate as described above, the state-action value function used to guide both the prompt confirmation module 140 and the anytime optimization module 160 is a non-myopic objective function. The objective function is “non-myopic” in the sense that it is dependent not only on the requests [symbol] that have already been accepted but also on a probabilistic distribution of requests [symbol] that may be received in the future.

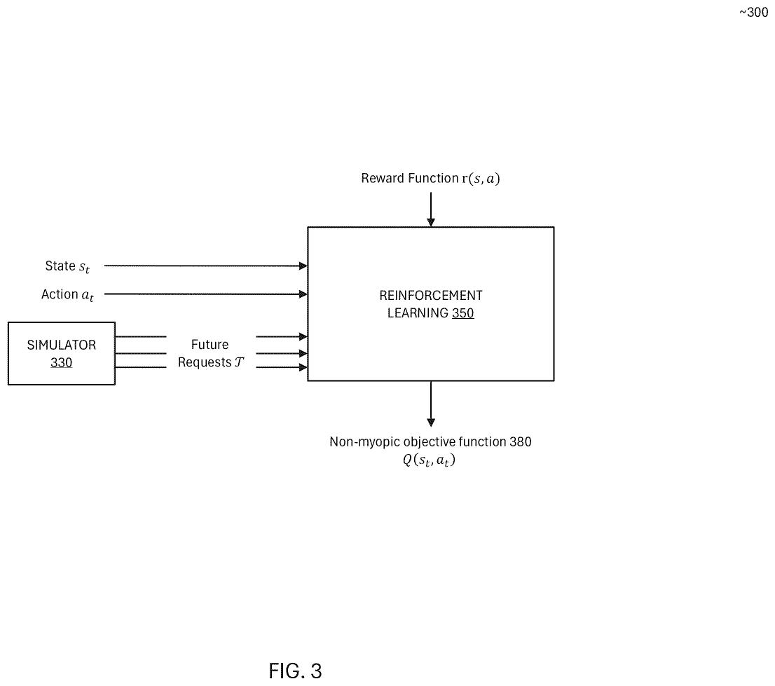

FIG. 3 is a block diagram of a process 300 for leaning the non-myopic objective function 380 using reinforcement learning. The learning process 300 is modeled as a sequential decision-making problem. As described above, the state sₜ of the environment at any time t is defined as a new request Tₖ, the current location [symbol] of each vehicle v∈ [symbol] , the set of requests [symbol] that are accepted but not completely served, and the route plans [symbol] of each vehicle v∈V. Meanwhile, an action aₜ denotes a decision at time t of either accepting the new request Tₖ or rejecting it (if accepting the request is not feasible given the constraints above). After an action, an action at the pre-decision state sₜ of the environment transitions into the post-decision state

$${s}_{t}^{post} .$$

The immediate reward of performing an action at is govern by the reward function r(sₜ,aₜ). If the action aₜ represents an acceptance of the new request Tₖ, then the reward r(sₜ,aₜ)=1; otherwise, the reward r(sₜ,aₜ)=0.

As shown in FIG. 3, the reinforcement learning module 350 learns the non-myopic objective function 380, which is the state-action value function Q (state, action) used by both the prompt confirmation module 140 and the anytime optimization module 160 to estimate both the immediate reward and the discounted sum of future rewards for each action in each state.

To identify the non-myopic objective function 380 for actions that achieve maximum rewards across a variety of future states, the reinforcement learning module 350 uses a simulator 330 to simulate the environment and the receipt of future requests T. After each step of the environment (an action and a state transition), the system records an experience tuple that includes the starting state sₜ, the action aₜ, the post-decision state

$${s}_{t}^{post} ,$$

and the immediate reward r(sₜ,aₜ).

The reinforcement learning module 350 identifies the non-myopic objective function 380 by gathering its experience, training a neural network to learn the state-action value function Q (state, action), and updating its estimates using the Bellman Equation:

$$( s , a ) = r ( s , a ) + γ ( {s}^{′} , {a}^{′} ) \qquad [ Equation 4 ]$$

The Bellman Equation allows the reinforcement learning module 350 to learn the maximum discounted sum of future rewards. The immediate reward r(s,a) is combined with an estimate (discounted by γ) of the value of the next best possible action a′ in the subsequent state s′. By constantly minimizing the error between its current Q prediction and that Bellman target, the reinforcement learning module 350 iteratively refines the objective function to maximize the service rate in the long term. The neural network may be an MLP network, a KAN, or a CNN.

### Supervised Pre-Training

While the reinforcement-based training described above with reference to FIG. 3 can eventually lead to the optimal solution, reinforcement learning is computationally expensive. Accordingly, in some embodiments, the dynamic vehicle routing system 100 may apply supervised learning for pre-training.

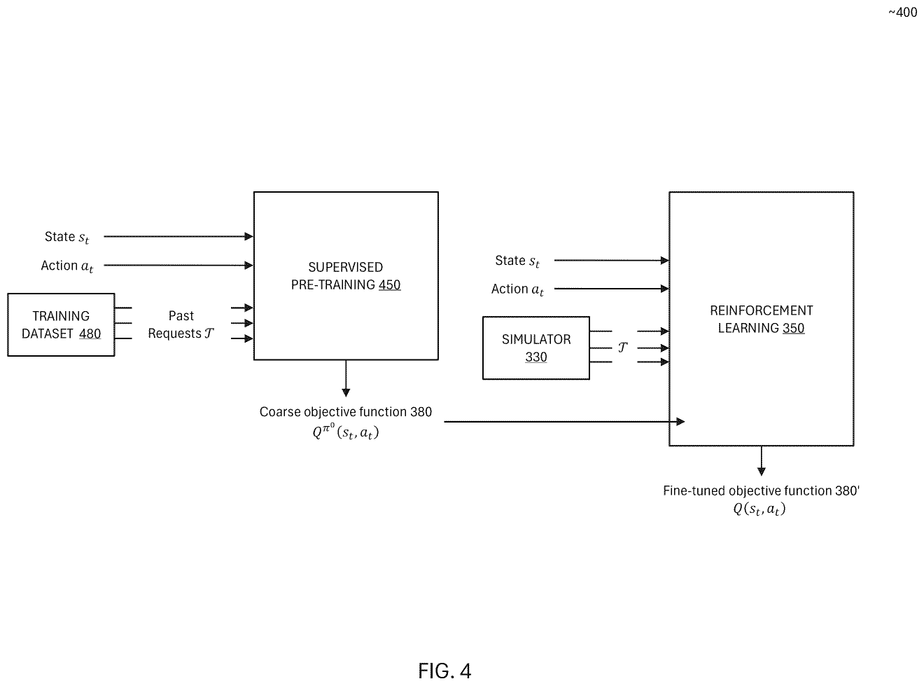

FIG. 4 is a block diagram of a supervised pre-training process 400 for learning a coarse objective function 380, which that then be refined by the reinforcement learning module 350 to learn a fine-tuned objective function 380′. As shown in FIG. 4, training dataset 480 of past requests (e.g., municipal microtransit data, the widely used New York City taxi dataset, etc.) is provided to a supervised pre-training module 450, which uses a simple policy π⁰ to generate an action value [symbol] (s,a) characterizing each action at in each state sₜ. For example, the policy π⁰ used to characterize each action at may be a determination of the idle times for next h hours:

$${π}^{0} ( {s}_{t} ) = {argmax}_{{a}_{t}} {\sum }_{{R}_{ν}}^{{ℛ}_{t}} {\sum }_{k = 1}^{\vert {R}_{ν} \vert - 1} ( {R}_{v} , k ) \qquad [ Equation 5 ]$$

where [symbol] is the route plan obtained after applying the action aₜ on the state sₜ and [symbol] (Rᵥ,k) represents the idle time between two consecutive stops in the route plan:

$$I ( {R}_{v} , k ) = \{ \begin{matrix}{τ}_{k + 1} - {τ}_{k} - {D}_{{L}_{k} , {L}_{k + 1}} , & {τ}_{k + 1} \leq t + h \\ max \{ 0 , t + h - {τ}_{k} - {D}_{{L}_{k} , {L}_{k + 1}} \} , & {τ}_{k} < t + h \leq {τ}_{k + 1} \\ 0 , & otherwise .\end{matrix}$$

To learn the coarse objective function 380 (the policy π⁰) via supervised learning, the supervised learning module 350 is provided with ground truth, in this case the action values [symbol] (s,a) estimated based on the discounted sum of the immediate rewards for next k steps:

$${Q}^{{π}^{0}} ( {s}_{t} , {a}_{t} ) \approx {\sum }_{i = 0}^{k - 1} {γ}^{i} r ( {s}_{t + i} , {a}_{t + i} ) \qquad [ Equation 6 ]$$

That estimated value Q^{π}^{⁰}(sₜ,aₜ) serves as the ground truth label for the supervised learning task, where the supervised pre-training module 450 trains a neural network to map the input state sₜ and action aₜ to the estimated long-term value Q^{π}^{⁰}(sₜ,aₜ). The neural network may be a Multilayer Perceptron (MLP) network, a Kolmogorov-Arnold Network (KAN), or a Convolutional Neural Network (CNN). Once the supervised pre-training module 450 converges on a coarse objective function 380 (the estimated state-value function Q^{π0}(sₜ,aₜ)), the reinforcement learning module 350 can be used to fine tune the weights of the neural network and identify a fine-tuned objective function 380′ (the state-value function Q(sₜ,aₜ)) as described above with reference to FIG. 3. Both the prompt confirmation module 140 and the anytime optimization module 160 then use that fine-tuned objective function 380′ (the learned state-value function Q(sₜ,aₜ)) to guide their real-time and continual decision-making.

While preferred embodiments have been described above, those skilled in the art who have reviewed the present disclosure will readily appreciate that other embodiments can be realized within the scope of the invention. Accordingly, the present invention should be construed as limited only by any appended claims.

What is claimed is:

1. A system for optimizing route plans for each vehicle in a fixed fleet of vehicles, the system comprising:
a database that stores current route plans for each of the vehicles and a set of accepted requests;
a prompt confirmation module, executed by a hardware processing unit, that:
receives an incoming request;
determines whether to accept the incoming request and assigns the accepted request to a selected vehicle by maximizing a non-myopic objective function; and
outputs a set of updated route plans that includes the accepted incoming request to the database; and
an anytime optimization module, executed by the hardware processing unit between the receipt of consecutive incoming requests, that:
optimizes the updated route plans by maximizing the non-myopic objective function; and
outputs the optimized updated route plans to the database as the current route plans for each of the vehicles.

2. The system of claim 1, wherein the anytime optimization module optimizes the updated route plans using an anytime meta-heuristic algorithm.

3. The system of claim 2, wherein the anytime meta-heuristic algorithm comprises Simulated Annealing (SA), Tabu Search (TS), Adaptive Large Neighborhood Search (ALNS), or Iterated Local Search (ILS).

4. The system of claim 1, wherein the non-myopic objective function is a state-action value function learned by training a neural network using reinforcement learning.

5. The system of claim 4, wherein:
the prompt confirmation module determines the selected vehicle by using the state-action value function to estimate a discounted sum of all future rewards; and
the anytime optimization module optimizes the updated route plans by using the state-action value function to estimate a discounted sum of all future rewards.

6. The system of claim 4, wherein:
the system further comprises a simulator that outputs a distribution of simulated future requests; and
the state-action value function is learned by using reinforcement learning to train the neural network on the distribution of simulated future requests.

7. The system of claim 4, wherein the non-myopic objective function is learned by:
using supervised pre-training to learn a coarse objective function; and
using the reinforcement learning to fine-tune the coarse objective function.

8. The system of claim 7, wherein the coarse objective function is learned by training the neural network on a dataset of past requests.

9. The system of claim 7, wherein the coarse objective function is learned by training the neural network to learn a heuristic policy for maximizing idle times of each vehicle.

10. The system of claim 4, wherein the neural network is a Multi-Layer Perceptron (MLP) network, a Kolmogorov-Arnold Network (KAN), or a Convolutional Neural Network (CNN).

11. A method of optimizing route plans for each vehicle in a fixed fleet of vehicles, the method comprising:
storing current route plans for each of the vehicles;
storing a set of accepted requests;
receiving an incoming request;
determining whether to accept the incoming request and assigning the accepted request to a selected vehicle by maximizing a non-myopic objective function;
storing a set of updated route plans that includes the accepted incoming request;
optimizing the updated route plans by maximizing the non-myopic objective function; and
storing the optimized updated route plans as the current route plans for each of the vehicles.

12. The method of claim 11, wherein the updated route plans are optimized using an anytime meta-heuristic algorithm.

13. The method of claim 12, wherein the anytime meta-heuristic algorithm comprises Simulated Annealing (SA), Tabu Search (TS), Adaptive Large Neighborhood Search (ALNS), or Iterated Local Search (ILS).

14. The method of claim 11, wherein the non-myopic objective function is a state-action value function learned by training a neural network using reinforcement learning.

15. The method of claim 14, wherein:
the accepted request is assigned to the selected vehicle by using the state-action value function to estimate a discounted sum of all future rewards; and
the updated route plans are optimized by using the state-action value function to estimate a discounted sum of all future rewards.

16. The method of claim 14, wherein:
the method further comprises generating a distribution of simulated future requests; and
the state-action value function is learned by using reinforcement learning to train the neural network on the distribution of simulated future requests.

17. The method of claim 14, wherein the non-myopic objective function is learned by:
using supervised pre-training to learn a coarse objective function; and
using the reinforcement learning to fine-tune the coarse objective function.

18. The method of claim 17, wherein the coarse objective function is learned by training the neural network on a dataset of past requests.

19. The method of claim 17, wherein the coarse objective function is learned by training the neural network to learn a heuristic policy for maximizing idle times of each vehicle.

20. The method of claim 14, wherein the neural network is a Multi-Layer Perceptron (MLP) network, a Kolmogorov-Arnold Network (KAN), or a Convolutional Neural Network (CNN).
